(19) United States
(12) Patent Application Publication
(10) Pub. No.: US 2007/0245564 A1
(43) Pub. Date: Oct. 25, 2007

(54) Shaver with rolling multi-cartridge head

(76) Inventor: Francis Yiu, Hong Kong (CN)

Correspondence Address: WHITE & CASE LLP;PATENT DEPARTMENT, 1155 AVENUE OF THE AMERICAS, NEW YORK, NY, 10036, US

(21) Appl. No.: 11/673,154

(22) Filed: Feb. 9, 2007

Related U.S. Application Data
(60) Provisional application No. 60/771,726, filed on Feb. 9, 2006.

(51) Int. Cl. B26B 21/24

(52) U.S. Cl. 30/40

(57) ABSTRACT

A shaver comprises (a) a handle; and (b) a rotatable central cartridge comprising a plurality of blade assemblies. The blade assemblies may be arranged in an arc on the periphery of the central cartridge, and the individual blades in the blade assemblies may be arranged in a single plane, in an arc, or in any other type of arrangement. In one embodiment, the rotatable central cartridge has three blade assemblies, and each of the blade assemblies has three or more separate blades. The structure and arrangement of the blade assemblies provides a close, safe and comfortable shave to the user.

This application claims the priority benefit of U.S. provisional patent appln. Ser. No. 60/771,726, filed on Feb. 9, 2006.

### FIELD OF THE INVENTION

This invention is directed to the field of grooming products. More specifically, the invention is directed to a shaver having a rotatable central cartridge which comprises a plurality of blade assemblies and which can be rotated to expose a fresh blade assembly when a used blade assembly becomes dull.

### BRIEF SUMMARY OF THE INVENTION

The present invention is directed to a shaver for shaving a user's skin. The shaver comprises (a) a handle; and (b) a rotatable central cartridge comprising a plurality of blade assemblies. In one embodiment, the rotatable central cartridge has three blade assemblies, and each of the blade assemblies has three or more separate blades. The blade assemblies may be arranged in an arc on the periphery of the central cartridge, and the individual blades in the blade assemblies may be arranged in a single plane, in an arc, or in any other type of arrangement. The structure and arrangement of the blade assemblies provides a close, safe and comfortable shave to the user.

Advantageously, the inventive shaver reduces the number of disposable razor blade cartridges and shavers entering the waste stream. In addition, by merely rotating the central cartridge at the top of the shaver, the user is able to exchange a dull blade assembly for a new blade assembly, and thereby avoid wasting time locating new cartridges.

The shaver cartridge can comprise a plurality of blade assemblies. In one embodiment, the shaver comprises three or more blade assemblies arranged in an arc on the periphery of the central cartridge. In other embodiments of the invention, there may be any combination of blade assemblies having three or more blades. There may also be less than three blades in certain blade assemblies, and the blade assemblies can be identical or different.

The central cartridge can have any particular cross-sectional shape, without limitation. For example, the central cartridge may have a circular cross-section, as illustrated in the Figures, or the central cartridge may have a non-circular cross-section, such as a triangular, square, or pentagonal shape. The central cartridge may optionally have a cylindrical shape. The blade assemblies can be arranged on the central cartridge in any convenient fashion.

The central cartridge may be attached to the handle using any kind of connection means. For example, in one embodiment, a cartridge may connect to the handle using a snap-fit connector. In an alternative embodiment, snap fittings which extend and retract from the cartridge may be used to connect the cartridge to the handle.

The entire shaver may be disposable after some or all of the blade assemblies on the central cartridge have been used. Alternatively, the handle may be reusable and the user may dispose of only the central cartridge after removal from the shaver handle when the blades are dulled. In a further embodiment, the handle and central cartridge are reusable and the user may replace individual used blade assemblies on the cartridge for new blade assemblies.

The shaver may optionally comprise a guard that covers one or more of the blade assemblies. In this manner, used or unused blade assemblies can be protected from damage such as from falls. The guard can also protect the user from inadvertent cuts when not using the shaver.

The shaver or the central cartridge may optionally have one or more features that facilitate shaving or reduce razor burn, such as moisturizing or lubricating strips. The handle of the shaver may optionally accommodate storage of one or more replacement central cartridges, or one or more replacement blade assemblies.

The shaver may optionally include a locking mechanism to control the forward or backward rotational movement of the central cartridge.

According to another aspect of the invention, a method of shaving a user's skin is provided. The method comprises providing the new shaver, and rotating the cartridge to expose an unused blade assembly when a currently-used blade assembly becomes dull.

For example, when the central cartridge comprises three blade assemblies, the cartridge can be rotated 120 degrees to retract, hide, or withdraw a dull blade assembly, and expose an unused blade assembly.

### BRIEF DESCRIPTION OF THE DRAWINGS

FIGS. 1A-1C illustrate front, side, and rear views of a first embodiment of the invention, wherein the rotatable cartridge comprises three blade assemblies and is affixed to the top of the handle by a snap-fit connector.

FIG. 1D illustrates a perspective view of the embodiment in FIGS. 1A-1C.

FIG. 1E illustrates a perspective view of the embodiment in FIGS. 1A-1C in which the rotatable cartridge is detached from the handle.

FIGS. 2A-2C illustrate front, side, and rear views of a second embodiment of the invention, wherein the rotatable cartridge comprises three blade assemblies and is affixed to the handle by snap fittings which are extendible longitudinally from the cartridge.

FIG. 2D illustrates a perspective view of the embodiment in FIGS. 2A-2C.

FIG. 2E illustrates a perspective view of the embodiment in FIGS. 2A-2C in which the rotatable cartridge has been detached from the handle.

FIGS. 2F and 2G illustrate the rotatable cartridge shown in FIGS. 2A-2E.

FIGS. 3A-3C illustrate front, side, and rear views of a third embodiment of the invention, wherein the handle comprises an enclosure for the rotatable cartridge, and the cartridge can be slid in and out of the enclosure for replacement.

FIG. 3D illustrates a perspective view of the embodiment in FIGS. 3A-3C.

FIG. 3E illustrates a exploded perspective view of the embodiment in FIGS. 3A-3D showing the individual elements.

### DETAILED DESCRIPTION OF THE INVENTION

The claimed invention will now be described with reference to the drawings, wherein like numerals correspond to like elements.

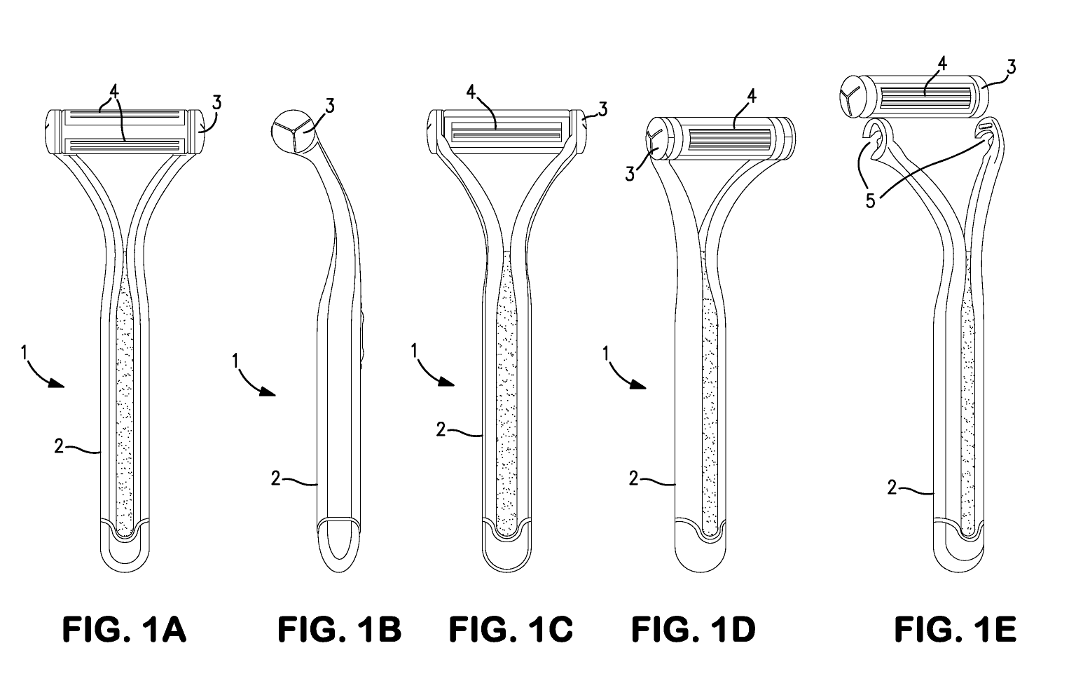

FIGS. 1A-1D illustrate a first embodiment 1 of the invention. This embodiment comprises a handle 2 and a rotatable cartridge 3. In this embodiments, the rotatable cartridge 3 comprises three blade assemblies 4 and is affixed to the top of the handle 2 by a snap-fit connector, although any number of blade assemblies and individual blades are within the scope of the present invention.

The handle 2 may be formed from any kind of material and may have any kind of structure. For example, the handle or portions thereof may be manufactured from plastic, metal, rubber, ceramics, composites, or any substance or combination of substances without limitation. In one embodiment, the handle may be provided with a comfort grip or coating which allows the user to firmly grasp and use the shaver without slippage which would otherwise detract from the use of the shaver.

The handle 2 may also have any convenient shape consistent with its intended use. Certain manufacturers may wish to design the handle so that it has a similar appearance to other shavers in their product line. The handle may optionally be imprinted with the manufacturer's logo or with another slogan for identification or advertising purposes.

For added user convenience, the handle 2 of the shaver may optionally accommodate storage of one or more replacement rotatable cartridges, or one or more replacement blade assemblies.

The rotatable cartridge 3 and its component blade assemblies 4 may be manufactured from any type of materials, such as plastic, metals, or any combination of materials without limitation. In one embodiment of the invention, the cartridge and the blade assemblies are made of plastic and the individual blades are made of a metal such as steel. The cartridge or the blade assemblies may have interstices or slats which allow running water to wash away cut hairs or shaving cream from the blades.

The rotatable cartridge 3 can have any convenient shape, such as a cylindrical or tubular shape, and any kind of cross-sectional appearance, such as circular, triangular, square, pentagonal, or arcuate.

The rotatable cartridge 3 can be designed to use generally-available blade assemblies which are manufactured and sold for existing traditional safety razors. Such a design allows the manufacturer to leverage an existing blade assembly and obviates the need to design and manufacture a new type of blade system. Alternatively, the rotatable cartridge 3 may use blade assemblies which are custom-designed for use in the present invention.

The rotatable cartridges may optionally have elements which improve the user's shaving experience. For example, the cartridge may have a moisturizing or lubricating strip, a bump-fighting area, or another feature deemed desirable by the manufacturer. Such additional features can provide a cosmetic or dermatological benefit to the user while shaving the skin.

The manufacturer may make the blade assemblies 4 an integral part of the rotatable cartridge 3 such that the entire cartridge is disposed of when the component blade assemblies are dulled from use. Alternatively, one or more of the individual blade assemblies 4 may be user-replaceable.

Although FIGS. 1A-1E illustrate the cartridge as having three blade assemblies, each having three individual blades, the rotatable cartridge 3 can comprise any number of blade assemblies 4 having any number of individual blades. These blade assemblies can be identical or different on a single cartridge. For example, the cartridge may have two, three, four, or more blade assemblies, and each blade assembly may have the same number of individual blades or a different number of blades. In one embodiment, the shaver comprises three or more blade assemblies arranged in an arc on the periphery of the central cartridge. In other embodiments of the invention, there may be any combination of blade assemblies having three or more blades. The blades, blade assemblies, or the cartridge may optionally have a pivoting or springing action to allow the blades to follow the contours of the face and provide closer shaving of the skin.

The individual blades in a particular blade assembly may have any convenient or conventional orientation. For example, the blades may be arranged in an arc or a plane. The blade assembly or each individual blade of the assembly may be spring-loaded to allow for closer shaving and an improved shaving experience. The blades may also be coated with a lubricious material for enhanced glide on the skin.

FIG. 1E illustrates a perspective view of the embodiment in FIGS. 1A-1D in which the rotatable cartridge 3 has been detached from the handle 2. The handle 2 of the shaver has connectors 5 which cooperate with snap fittings on the rotatable cartridge 3 to secure the cartridge from inadvertent movement. For example, the connectors or snap fittings may have detents or a ratcheting or locking mechanism, or be biased to remain in a secured position. Connection means such as snap fittings permit the user to overcome any bias to actively rotate the cartridge for use of a new blade assembly and yet restrict inadvertent or casual movement of the cartridge. For example, a user may place his fingers on opposed ends of the cartridge and actively turn the cartridge to expose a new blade assembly. Such mechanisms are known to those of skill in the art.

In FIGS. 1A-1E, the handle 2 is illustrated as having a “forked” appearance at its top end. Each fork has a connector 5 which cooperates with a snap fitting on opposing sides of the rotatable cartridge 3. However, the structure of the handle and the number and placement of the connectors to the cartridge is not critical. For example, the handle may have a non-forked structure, or may have only a single connector which cooperates with a single fitting or locking mechanism located on the cartridge. The fitting(s) may be located at any position on the cartridge, such as in the middle or at one or both ends of the cartridge. All such attachment means, structures, and mechanisms are within the scope of the present invention without limitation.

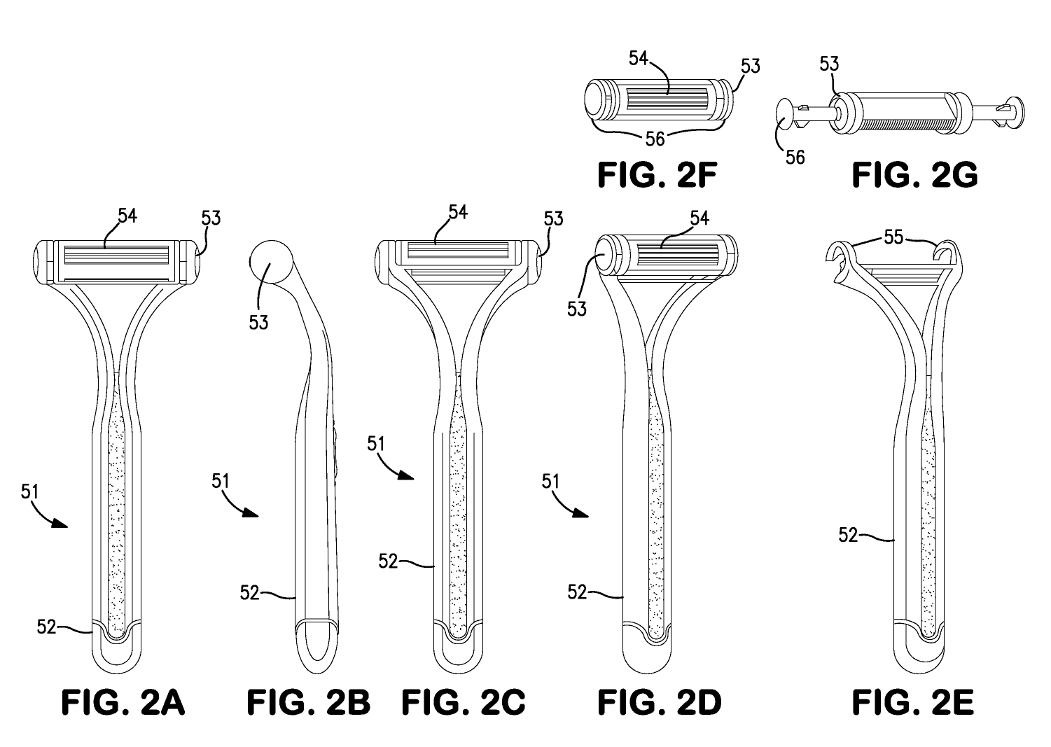

FIGS. 2A-2D illustrate a second embodiment of the invention, wherein the rotatable cartridge comprises three blade assemblies and is affixed to the handle by snap fittings which are extendible longitudinally from the cartridge. FIG. 2E and FIGS. 2F-2G respectively illustrate the handle and the rotatable cartridge of this second embodiment of the invention.

FIGS. 2A-2E illustrate the shaver 51 as comprising a handle 52 and a rotatable cartridge 53. The cartridge 53 comprises three separate blade assemblies 54, each of which has three individual blades arranged in an arc on the periphery of the rotatable cartridge 53. The handle 52 of the shaver has connectors 55 which cooperate with snap fittings 56 on the rotatable cartridge 53 to secure the cartridge from inadvertent movement.

The rotatable cartridge is illustrated with more clarity in FIGS. 2F and 2G The snap fittings 56 of the cartridge 53 extend longitudinally from the cartridge to allow for ready rotation of the cartridge, and to facilitate detachment from the handle and exchange of a used blade for a new one. The snap fittings 56 have protrusions or detents which assist in locking the fittings to the connectors 55 of the handle 52 when in fittings are in the closed position. For clarity, FIG. 2G illustrates the structure of the cartridge 53 without accompanying blade assemblies.

In this embodiment of the invention, the longitudinal snap fittings are extended from the cartridge to unlock the cartridge. In the unlocked position, the cartridge can be rotated or replaced with another cartridge. After rotation or replacement, the cartridge may be locked in position by pushing the longitudinal snap fittings into the cartridge.

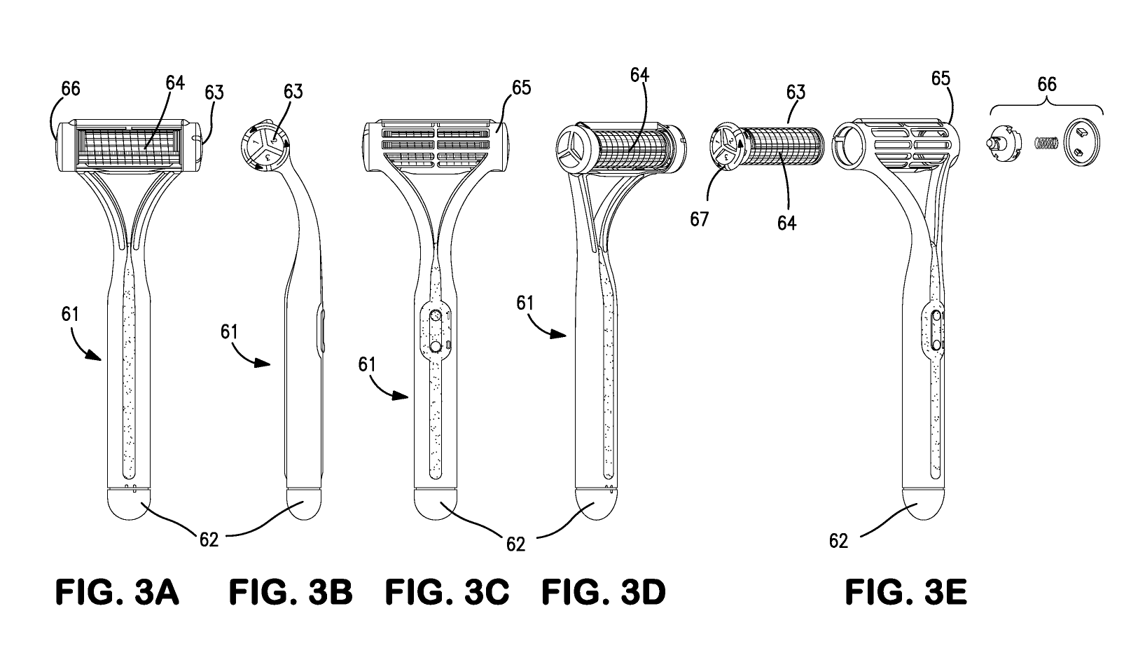

FIGS. 3A-3C illustrate front, side, and rear views of a third embodiment of the invention, wherein the handle comprises an enclosure for the rotatable cartridge, and the cartridge can be slid in and out of the enclosure for replacement. FIGS. 3D and 3E respectively illustrate perspective and exploded perspective views of the embodiment in FIGS. 3A-3C.

FIG. 3A-3E illustrate the shaver 61 as comprising a handle 62 and a rotatable cartridge 63. The cartridge comprises three separate blade assemblies 64, each of which has three individual blades arranged in an arc on the periphery of the rotatable cartridge 63. The handle 62 of the shaver has an enclosure 65 into which the rotatable cartridge 63 is inserted prior to use. In this embodiment, the cartridge 63 cooperates with a snap connector 66 to removably secure the cartridge in the enclosure 65.

The rotatable cartridge 63 of this embodiment is illustrated with more clarity in FIG. 3E. One side of the cartridge has a thumbscrew 67 which allows the user to readily turn the cartridge to expose a fresh blade assembly. The thumbscrew is imprinted with the numbers 1, 2, and 3 which correspond to a particular blade assembly. The other side of the cartridge has a connection for a snap connector to prevent the cartridge from moving inadvertently or from falling out of the enclosure. Although the snap connector is shown as comprising two discs and an internal spring, the snap connector can have any type of configuration or mechanism. The snap connector, thumbscrew, or cartridge may also have means such as a groove or ridge for ensuring that the cartridge is rotated a predetermined amount to fully expose a new blade surface.

Prior to use, the cartridge 63 is inserted into the enclosure 65 and the snap connector 66 is pressed to the cartridge to removably lock the cartridge in the enclosure. When a blade assembly becomes dulled from use, for example, blade assembly “1”, the cartridge can be rotated a prescribed amount, such as 120°, using the thumbscrew 67 and thereby expose a fresh blade surface such as “2” for use. The user may also rotate the thumbscrew and snap connector together to turn the cartridge. When all the blade assemblies become dull, the user can easily detach the snap connector from the side of the cartridge and remove and dispose of the spent cartridge. A new cartridge is then inserted into the enclosure and the snap connector is affixed to the new cartridge to secure it in place. The enclosure has slits which permit water to wash away cut hairs from the shaver.

Although this embodiment of the shaver has been described as having a user-replaceable cartridge, in other embodiments the shaver may be provided as a single disposable item of manufacture. In such an alternative embodiment, the snap connector would be permanently mounted to the cartridge and thereby restrict the user from replacing the cartridge. When the blade assemblies of this disposable embodiment become dull, the entire shaver would be discarded and replaced by a new shaver.

The shaver can be used to trim hairs from any portion of the body, such as the beard area, legs, or arms. The shaver is used in the conventional manner, that is, by moving an exposed blade assembly along the skin to cut hairs. Although not essential, a user may apply a lubricious material such as shaving cream, foam, gel, or oil to the skin to soften the hairs being cut and reduce drag on the blades.

In accordance with the present invention, when a particular blade assembly has become dulled from use, the user will turn the cartridge to hide, retract, or otherwise move the used blade assembly in such a manner as to prevent or restrict further use. For example, the used blade assembly may be rotated or withdrawn into the body of the cartridge to prevent further use. An unused blade assembly will become exposed and allow the user to shave with a fresh blade surface. The particular mechanism by which the cartridge is rotated is not critical to the invention and therefore different mechanisms may be used without limitation.

The amount of rotation needed to expose a new blade assembly will depend upon the particular design of the cartridge. For example, when the central cartridge comprises three blade assemblies, the cartridge may need to be rotated about 120 degrees to expose an unused blade assembly. Depending upon its design, the cartridge may need to be rotated to a greater or lesser degree to expose a new blade assembly. For example, the cartridge may need to be rotated only 90 degrees to expose a new blade assembly.

While the invention has been particularly shown and described with reference to particular embodiments, those skilled in the art will understand that various changes in form and details may be made without departing from the spirit and scope of the invention.

What is claimed is:

1. A shaver comprising:
a handle; and
a rotatable central cartridge comprising a plurality of blade assemblies, wherein each blade assembly has three or more separate blades.

2. The shaver according to claim 1, wherein the blade assemblies are arranged in an arc on the periphery of the central rotatable cartridge.

3. The shaver according to claim 1, wherein the individual blades in the blade assemblies are arranged in a single plane.

4. The shaver according to claim 1, wherein the individual blades in the blade assemblies are arranged in an arc.

5. The shaver according to claim 1, wherein the central cartridge has a circular or a non-circular cross-section.

6. The shaver according to claim 1, wherein the central cartridge has a triangular, square, or pentagonal cross-section.

7. The shaver according to claim 1, wherein the central cartridge has a generally cylindrical shape.

8. The shaver according to claim 1, wherein the shaver is disposable.

9. The shaver according to claim 1, wherein the central cartridge is disposable.

10. The shaver according to claim 1, wherein the individual blade assemblies are disposable.

11. The shaver according to claim 1, wherein the central cartridge comprises three or more blade assemblies.

12. The shaver according to claim 1, wherein the central cartridge comprises four or more blade assemblies.

13. The shaver according to claim 1, further comprising a guard that covers one or more of the blade assemblies.

14. The shaver according to claim 1, further comprising a locking mechanism which controls the forward or backward rotational movement of the central cartridge.

15. The shaver according to claim 1, wherein the handle accommodates storage of one or more replacement central cartridges.

16. The shaver according to claim 1, wherein the handle accommodates storage of one or more replacement blade assemblies.

17. A method of shaving a user's skin, comprising: providing the shaver according to claim 1; and rotating the cartridge to expose an unused blade assembly when a currently-used blade assembly becomes dull.

18. The method according to claim 17, wherein the central cartridge comprises three blade assemblies and the cartridge is rotated 120 degrees to expose an unused blade assembly.
